(19) United States
(12) Patent Application Publication
(10) Pub. No.: US 2016/0026967 A1
(43) Pub. Date: Jan. 28, 2016

(54) METHOD FOR ASSISTING IN COLLECTION OF GOODS BY A VEHICLE

(71) Applicant: FORD GLOBAL TECHNOLOGIES, LLC, Dearborn, MI (US)

(72) Inventors: Jitendra SHAH, Kolkata (IN); Christian RESS, Aachen NRW (DE); Stefan WOLTER, Wuerselen NRW (DE)

(21) Appl. No.: 14/804,067

(22) Filed: Jul. 20, 2015

(30) Foreign Application Priority Data
Jul. 25, 2014 (DE) 102014214624.0

(51) Int. Cl. G06Q 10/08; G07C 9/00; G05D 1/00

(52) U.S. Cl. CPC G06Q 10/083; G05D 1/0088; G07C 9/00174

(57) ABSTRACT

A method of enabling collection of goods supplied by a provider is initiated by a user placing an order with a provider, the order identifying goods and a vehicle scheduled to collect the goods. In response to the order, the provider generates a code that relates the order with information identifying the scheduled collection vehicle. The provider transmits the code to a communication device operated by a delivery person at a collection point. Upon arrival of the vehicle at the collection point, the delivery person reads the vehicle information from the vehicle and enters it into the device to thereby trigger transmission of the code from the device. Upon receipt by the vehicle of the code, a vehicle compartment is unlocked so that it may be opened for loading of the goods.

### CROSS-REFERENCE TO RELATED APPLICATIONS

This application claims foreign priority benefits under 35 U.S.C. §119(a)-(d) to DE 10 2014 214 624.0 filed Jul. 25, 2014, which is hereby incorporated by reference in its entirety.

### TECHNICAL FIELD

The invention relates to a method and a device for assisting the process of collecting goods.

### BACKGROUND

The routine purchase of everyday articles such as, for example, foodstuffs, constitutes a burdensome and tedious task for many people.

JP 2009-211476 A discloses, inter alia, a system for assisting the provision of a transportation service for purchased goods acquired by a user to the parked position of a plug-in vehicle of the respective user, in which system a purchase management system which is present at the business is linked to an on-board system which is present onboard the parked plug-in vehicle which is connected to a charging cable and to a telecommunications cable. The system has, in particular, an apparatus for specifying the parked position of the respective vehicle, an unlocking device for unlocking the trunk or the vehicle doors of the respective motor vehicle after the purchased goods have been transported to the parked position of the vehicle and a vehicle-mounted reading device (tag reader) for reading an identifier which is present, for example, on the crate or shopping basket. In this context, the trunk can be unlocked on the basis of a comparison between key information which is present in the vehicle-mounted system and the identifier which is present on the crate or shopping basket.

### SUMMARY

According to an embodiment disclosed herein, a method of enabling collection of goods supplied by a provider is initiated by receiving an order identifying goods and a vehicle scheduled to collect the goods. In response to the order, a code is generated that relates the order with information identifying the scheduled collection vehicle. The code is transmitted to a communication device operated by a delivery person at a collection point, and upon arrival of the vehicle at the collection point the vehicle information is entered into the device to thereby trigger transmission of the code from the device. Upon receipt by the vehicle of the code, a vehicle compartment is unlocked so that it may be opened for loading of the goods.

According to a another disclosed embodiment, a method comprises receiving an order for goods, generating a code relating the order with information identifying a scheduled collection vehicle, and transmitting the code to a communication device at a collection point. Upon arrival of the scheduled vehicle, the identifying information is read from the vehicle and entered into the device thereby causing the device to transmit the code to the vehicle. Receipt of the code enables opening of a vehicle compartment to permit the goods to be loaded into the vehicle.

According to a another disclosed embodiment, a method comprises communicating to a provider an order for goods, the order including information identifying a vehicle scheduled to collect the goods, and dispatching the vehicle to a collection point where the goods are to be picked up. At the collection point, the vehicle receives a code generated by the provider in response to the order and transmitted from a wireless device. The transmission of the code to the vehicle is triggered by input of the vehicle identifying information into the device by a delivery person. Receipt of the code by the vehicle enables opening of a vehicle compartment to permit loading of the goods.

### BRIEF DESCRIPTION OF THE DRAWINGS

FIG. 1A shows a schematic side view of a vehicle arriving at a provider's collection point;

FIG. 1B shows a schematic rear view of the vehicle of FIG. 1;

FIG. 2 shows a schematic view of the vehicle at the collection point along with goods to be collected and a delivery person;

FIG. 3 shows a schematic rear view of the vehicle after being loaded with the goods of FIG. 2; and

FIG. 4 shows a flowchart explaining a typical exemplary sequence of the disclosed method.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In a method for assisting the process of collecting goods, the ordered goods are made available by a providing business (“the provider”) in response to a corresponding request by a user acquiring the goods, and said goods are brought by a delivery person (who may be an agent or representative of the provider) to a vehicle dispatched by the user.

The method utilizes a wireless data transmission between the user (the person or persons acquiring the purchased goods) and the provider's business, an access code for opening (and optionally also closing) a compartment (such as a trunk) of the vehicle is generated by the provider in order to permit the delivery person to load the purchased goods into the vehicle independently of any further action by the user.

The method enables the use of an autonomous motor vehicle to collect ordered goods and involves optimizing the communication between the respective business, the person acquiring the goods and the autonomous vehicle, wherein wireless communication technology is utilized for the exchange of information between the autonomous vehicle and a delivery person (made available by and representing the provider).

As used herein the term “collect” is defined as: “to get and bring with one; specifically: pick up.” (From Merriam Webster Dictionary, on-line edition, accessed on 13 Jul., 2015.)

According to one embodiment, the collecting vehicle is an autonomous vehicle which is configured to travel in at least partially automatically navigating fashion along a route to the collection point of the business making available the ordered goods. It is therefore possible, in particular, for the autonomous motor vehicle to be dispatched in an automatically navigating fashion in order to collect ordered goods from the corresponding distribution center.

According to one embodiment, the correct loading of the ordered goods into the vehicle is verified. In particular, the ordered goods which have been packed by the provider or made available for collection (or which have already been loaded into the vehicle compartment) can be identified and the correct provision or loading of the ordered goods can be checked, for example using a barcode scanner or a wireless identification method. Furthermore, a camera which is mounted in or on the vehicle (inside the compartment, for example) can also be used to identify the goods placed in the trunk and record or transmit corresponding data during the collection or delivery process. In addition, during the process of loading the goods into the trunk it is also possible to activate a camera-assisted 360° all-round viewing facility.

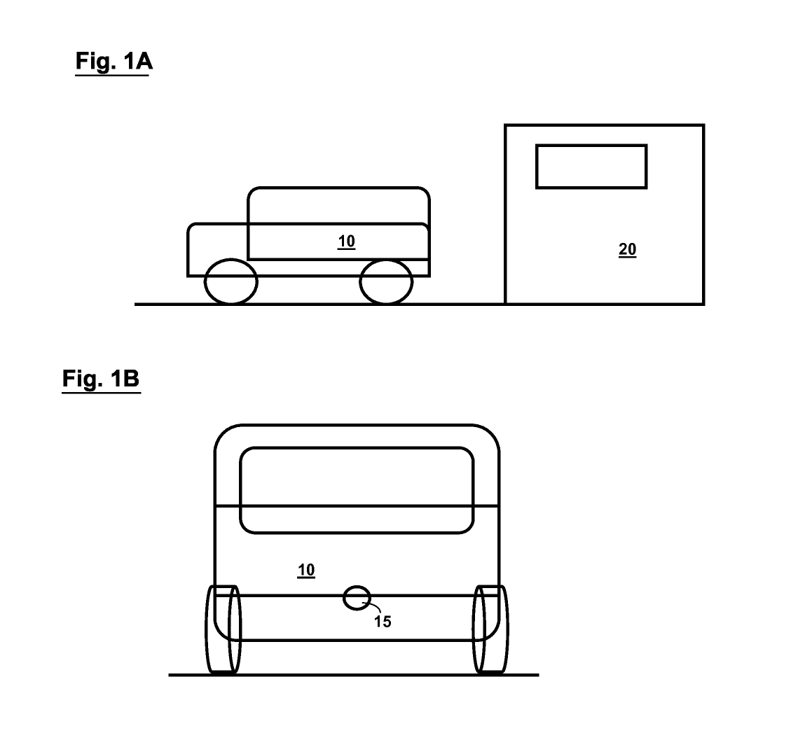

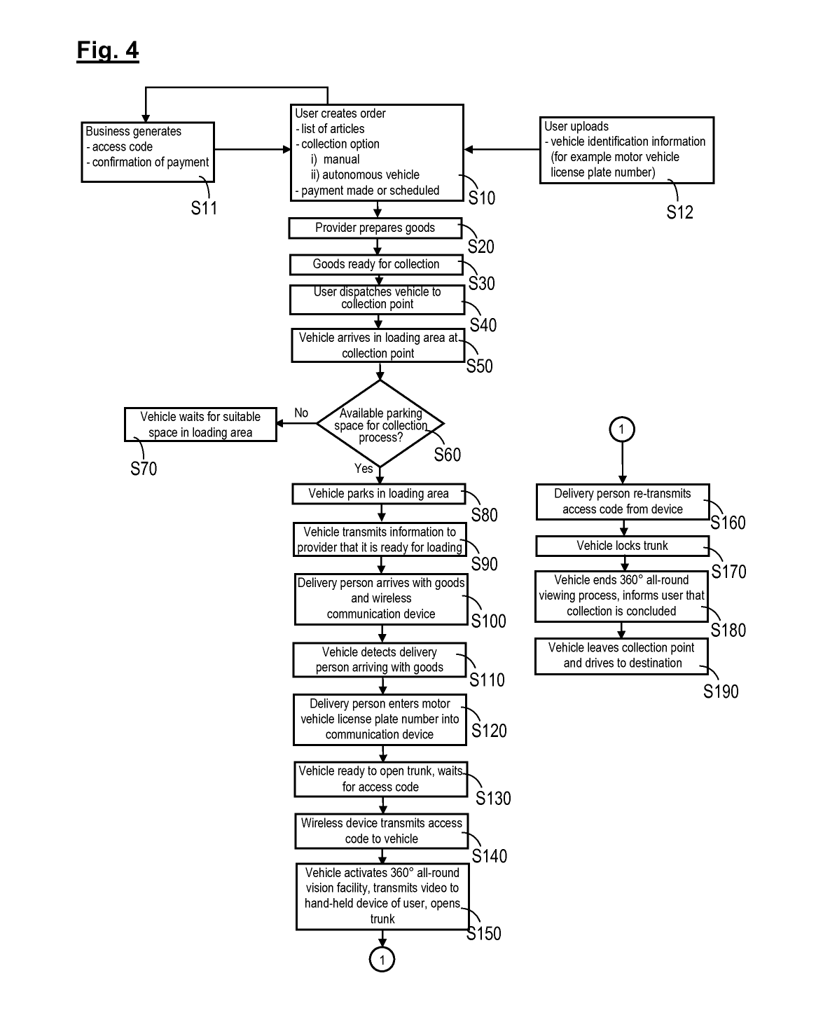

In the text which follows, a typical exemplary sequence of a method according to the invention and the components used to perform said method are explained with reference to the schematic illustrations in FIGS. 1-3 and the flowchart illustrated in FIG. 4.

At the start of the method, the user (the party acquiring the goods) creates, according to step S10 in FIG. 4, an order listing the goods desired for collection. The order may also include, for example, the possibility of making an input with respect to a collection option (as to whether the collection will be made manually or by using the autonomous vehicle). In addition, the user may make or schedule payment for the goods.

Then, in step S11 the provider 20 of the goods creates an access code and a payment confirmation. Furthermore, in step S12 the user uploads into the system vehicle identification information (typically the license plate number) of a vehicle scheduled to collect the goods of the order. The vehicle identification information is included in or otherwise associated with the goods order and with the access code for use in later steps.

Subsequently, in step S20 the ordered goods are packed (and/or otherwise prepared for collection) by the provider 20 or by corresponding personnel, with the result that the goods 50 are then available for collection (S30). In the exemplary embodiment, the user then dispatches an autonomous vehicle 10 (the vehicle which has been scheduled to collect the goods and for which the identification information has been associated with the order) for the collection in step S40, which autonomous vehicle 10 arrives in the loading area (for example carpark of the collection point identified by the provider 20) in step S50. The invention is not restricted to automatic navigation of the vehicle 10 to the collection point. For example, in further embodiments it is also possible for the user to drive the vehicle 10, partially or completely, to the collection point.

In step S60 it is checked whether there is a parking space available at the collection point that is suitable for the collection of the goods 50. If this is not the case, in step S70 the autonomous vehicle 10 waits nearby and continues the checking or interrogation for an available suitable parking space. As soon as a suitable parking space is available at the collection point, in step S80 the autonomous vehicle 10 parks in the loading area. This may be, for example, in front of the provider 20, as is illustrated in FIGS. 1A-B both in a side view (FIG. 1A) and in a rear view (FIG. 1B). In addition, a locking means 15 for a compartment (such as a trunk) capable of holding the goods is indicated in FIG. 1B.

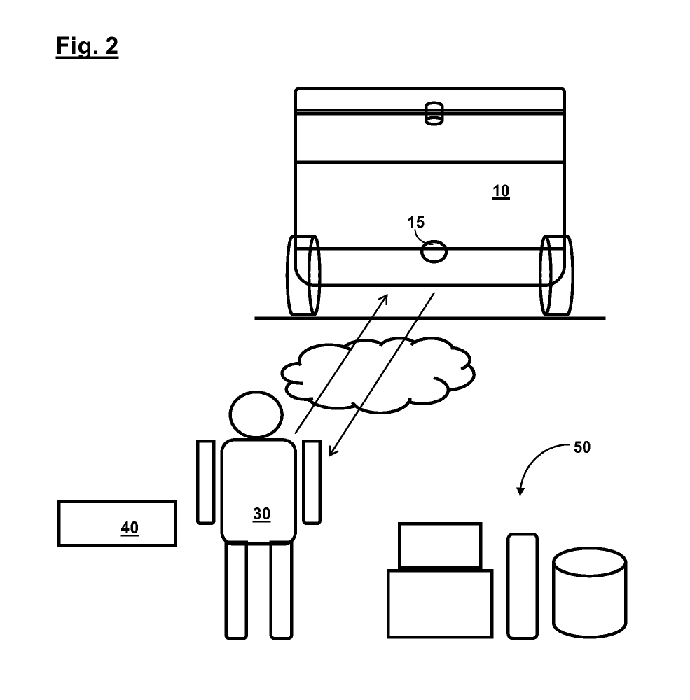

Subsequently, in step S90 the autonomous vehicle 10 transmits a signal to the provider 20 that it is ready for the loading process. A delivery person 30 made available by the provider 20 then proceeds with the goods 50 to the vehicle 10. The delivery person arrives at the vehicle according to step S100 and the schematic illustration in FIG. 2. The delivery person 30 carries a wireless communication device 40 on his person.

In step S110, the autonomous vehicle 10 detects the delivery person 30 who has arrived with the goods 50. In step S120, the delivery person 30 reads the motor vehicle license plate number (or other identifying information) visible on the vehicle and enters it into the communication device 40. In step S130, the autonomous vehicle 10 is ready to open the compartment and waits for the input of an access code by the delivery person 30, which takes place in step S140 for the opening of the compartment. Subsequently, in step S150 the autonomous vehicle 10 activates a 360° all-round viewing facility, wherein, in addition, a corresponding video can be transmitted to a hand-held device (for example a mobile phone or smartphone) which is carried on the user's person. The compartment is opened by activating the compartment locking means 15.

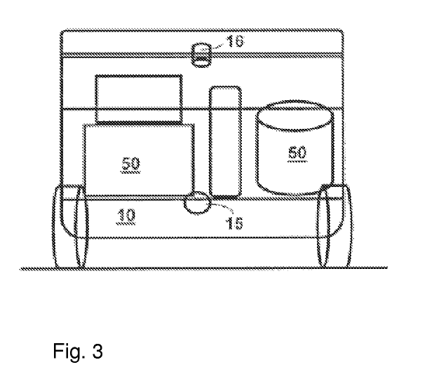

After loading of the goods 50 into the compartment is complete (this “loading complete” state shown in FIG. 3, with a trunk lid or hatch of the compartment open so that the goods 50 are visible), in step S160 the delivery person 30 enters the access code for locking the compartment, after which in step S170 the autonomous vehicle 10 locks the compartment. Furthermore, after the loading of the goods 50 into the vehicle 10 is complete, the correct loading of the goods 50 can be verified or checked, for which purpose, for example, a camera 16 which is mounted in the compartment of the vehicle 10 can be used according to FIG. 3. The autonomous vehicle 10 subsequently ends the 360° all-round viewing process in step S180 and informs the user that the collection process is concluded. In step S190, the autonomous vehicle 10 leaves the parking space and drives to a desired destination (for example the user's residence).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of enabling collection of goods supplied by a provider comprising:
receiving an order identifying goods and a vehicle scheduled to collect the goods;
in response to the order, generating a code relating the order with information identifying the vehicle;
transmitting the code to a communication device at a collection point;
upon arrival of the vehicle at the collection point, entering the vehicle information into the device to thereby trigger transmission of the code from the device; and
upon receipt by the vehicle of the code, unlocking a vehicle compartment to receive the goods.

2. The method of claim 1, wherein the vehicle is an autonomous vehicle.

3. The method of claim 1, wherein the code is generated after payment has been made for the goods.

4. The method of claim 1, further comprising verifying correct loading of the goods into the vehicle.

5. The method of claim 4, further comprising informing a user remote from the collection point that loading is complete via a wireless communication link.

6. The method of claim 4, wherein the verification comprises operating a camera mounted to the vehicle to image an interior of the compartment.

7. The method of claim 6, wherein the camera is capable of providing an image of an area surrounding the vehicle.

8. A method comprising:
receiving an order for goods;
generating a code relating the order with information identifying a scheduled collection vehicle;
transmitting the code to a communication device at a collection point; and
upon arrival of the vehicle, entering the information into the device thereby causing the device to transmit the code to the vehicle, receipt of the code enabling opening of a vehicle compartment to receive the goods.

9. The method of claim 8, wherein the vehicle is an autonomous vehicle.

10. The method of claim 8, wherein the code is generated after payment has been made for the goods.

11. The method of claim 8, further comprising verifying correct loading of the goods into the vehicle.

12. The method of claim 11, further comprising informing a user remote from the collection point that loading is complete via a wireless communication link.

13. The method of claim 11, wherein the verification comprises operating a camera mounted to the vehicle to image an interior of the compartment.

14. The method of claim 13, wherein the camera is capable of providing an image of an area surrounding the vehicle.

15. A method comprising:
communicating to a provider an order for goods including information identifying a vehicle scheduled to collect the goods;
dispatching the vehicle to a collection point; and
at the collection point, receiving at the vehicle a code transmitted from a wireless device and triggered by input of the information into the device, the code generated by the provider in response to the order and enabling opening of a vehicle compartment.

16. The method of claim 15, wherein the vehicle is an autonomous vehicle.

17. The method of claim 15, wherein the code is generated after payment has been made for the goods.

18. The method of claim 15, further comprising verifying correct loading of the goods into the vehicle.

19. The method of claim 18, further comprising informing a user remote from the collection point that loading is complete via a wireless communication link.

20. The method of claim 18, wherein the verification comprises operating a camera mounted to the vehicle to image an interior of the compartment.
